(19) United States
(12) Patent Application Publication
(10) Pub. No.: US 2010/0036948 A1
(43) Pub. Date: Feb. 11, 2010

(54) ZONING SCHEME FOR ALLOCATING SAS STORAGE WITHIN A BLADE SERVER CHASSIS

(75) Inventors: Daniel Cassiday, Burlington, MA (US); Michael Derbish, Pleasanton, CA (US); Chia Y. Wu, Palo Alto, CA (US)

Correspondence Address: OSHA LIANG L.L.P./SUN, TWO HOUSTON CENTER, 909 FANNIN, SUITE 3500, HOUSTON, TX, 77010, US

(73) Assignee: SUN MICROSYSTEMS, INC., Santa Clara, CA (US)

(21) Appl. No.: 12/187,182

(22) Filed: Aug. 6, 2008

(51) Int. Cl. G06F 15/173

(52) U.S. Cl. 709/225

(57) ABSTRACT

In a method for partitioning SAS storage within a blade server chassis, where the blade server chassis may include one of a plurality (N) of server blades, the same plurality (N) of SAS storage blades or any combination thereof up to a total of N blades, in order for the plurality of SAS storage blades to be securely shared by the plurality of server blades, a pair-based zoning scheme may be implemented whereby if a server blade and a disk blade occupy neighboring slots in the blade server chassis, a pair of the server blade and the disk blade may be set to belong in the same zone. Partitioning of SAS expansion ports within the blade server chassis may be accomplished by providing exclusive access of a single SAS expansion port to a server blade located in an even slot.

### BACKGROUND OF INVENTION

1. Field of the Invention

The invention relates generally to a zoning scheme implemented in a blade server chassis. More specifically, this invention relates to a method for partitioning Serial Attached Small Computer System Interface (SCSI) or SAS storage within a blade server chassis, where SAS storage blades are securely shared by server blades through the implementation of a “pair-based zoning” scheme.

2. Background Art

Due to ever-increasing demand for high density computing power, along with a need to secure data content and simultaneously deliver data efficiently, there arises a necessity of connecting groups of targets in blade server environments. SAS has proven to be very much of interest in addressing these storage connectivity issues because of low cost and interconnectivity beyond that of traditional SCSI. By way of employing expanders, support of up to 2¹⁴ or 16384 devices is provided.

Thus, the capability of linking multiple hosts and targets can be achieved. In the case of blade server environments, allowing targets to access resources from servers requires controlling the sharing of the resources. A mechanism for either grouping devices together or isolating devices from each other needs to be implemented in order to achieve correctness of operation in data management. This is accomplished by “zoning.” Zoning can render Hard Disk Drives (HDDs) owned by one host (i.e. OS on a processor blade) unavailable for access by other hosts.

Zoning is a recent addition to the SAS architecture and is defined in the SAS specification. Before the advent of SAS-2, the second generation SAS, some developed pre-SAS-2 zoning approaches are implemented in the expanders used in Constellation systems. It is expected that later versions of these expanders that are compliant to the SAS-2 specification will be available. The interfaces employed shall be used on both the preceding and compliant versions.

### SUMMARY OF INVENTION

In general, in one aspect, the invention relates to a method for partitioning SAS storage within a blade server chassis, and partitioning SAS expansion ports within the blade server chassis. The blade server chassis may be capable of housing N server blades, N storage blades, or any combination thereof up to a total of N blades. Connectivity between SAS storage blades and server blades may be provided via a pair of redundant, dual-domained SAS switches. The SAS switches may also include multiple expansion ports.

In one aspect of the invention, in order for SAS storage blades to be securely shared by server blades, a “pair-based” zoning may be implemented, whereby if a server blade and a storage blade occupy neighboring slots in the blade server chassis, the pair of server-storage blades may be set to belong in the same zone.

In another aspect of the invention, in order for SAS expansion ports to be securely shared by server blades, a “slot-ordered” zoning may be implemented, whereby if a server blade is located in an even slot, exclusive access to a single SAS expansion port may be provided.

Other aspects and advantages of the invention will be apparent from the following description and the appended claims.

### BRIEF DESCRIPTION OF DRAWINGS

FIG. 1 shows a blade server chassis, and zoning in the blade server environment in accordance with one embodiment of the invention.

FIGS. 2a-2b show the steps involved in setting zoning permissions in the unmanaged mode in accordance with one embodiment of the invention such that a Zoning Permission Table is completed.

FIG. 3 shows a rule of zone group assignments as a table in accordance with the above embodiment of the invention.

FIG. 4 shows a completed Zoning Permission Table in accordance with the above embodiment of the invention (Dst—Destination, and Src—Source).

FIG. 5 shows the zoning steps involved after a link reset when in managed mode in accordance with one embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the present invention describe a specific method for partitioning SAS storage within a blade server chassis, and partitioning SAS expansion ports within the blade server chassis. In one or more embodiments of the invention, the blade server chassis may be capable of housing N server blades, N SAS storage blades, or any combination thereof up to a total of N blades. Each storage blade constitutes a leaf node in a SAS tree and each server blade is a root node of the SAS tree. In one embodiment, connectivity between SAS storage blades and server blades may be provided via a pair of redundant, dual-domained SAS switches. In addition to providing connectivity between server blades and storage blades, the aforementioned SAS switches may also include multiple expansion ports, which may be used to connect to another SAS switch or to external SAS storage.

As an example in accordance with the above embodiment, a Sun Constellation blade chassis C10 may have ten blade slots. The C10 chassis may also additionally have twenty I/O card slots, two shared I/O module bays, and a Chassis Management Module (CMM) slot. Each blade slot may accept two types of blades, for example, a processor blade (server blade) or a storage blade. If a storage blade is present, at least one Network Express Module (NEM) may be installed to make the Hard Disk Drives (HDDs) on the storage blades available to the server blades.

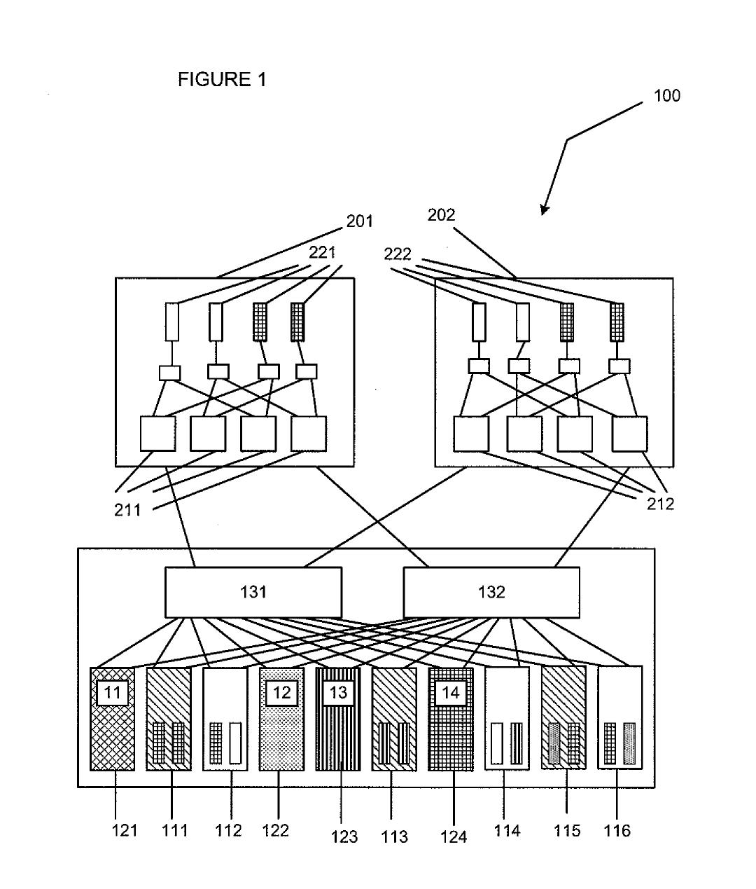

FIG. 1 shows a C10 constellation 100, where the C10 may be configured with six storage blades (111-116), two Network Express Modules (NEMs) (131, 132), and two Just a Bunch of Disks (JBODs) (201, 202). Each NEM may compose a SAS domain, and each processor blade and storage blade may have a single x2 connection to each of the SAS domains. Because two NEMs (131, 132) may be present, one of the links on each storage blade may be connected to each of the NEMs (131, 132), and may provide two distinct fabrics for access. The NEMs (131, 132) themselves may have external SAS ports that, in turn, may be connected to a pair of JBODs (201, 202), as shown in FIG. 1, In one or more embodiments, the drives in a JBOD may be Serial Advanced Technology Attachment (SATA) drives (221, 222) connected to the expanders (211, 212) using port selectors.

In one or more embodiments of the invention, in order that storage blades may be securely shared by server blades, i.e., one server blade may have exclusive access to certain storage blades while other server blades may have exclusive access to certain other storage blades, the blade server chassis may implement a “pair-based” zoning scheme, whereby if a server blade and a storage blade occupy neighboring slots in the blade chassis, the pair of server and storage blades are said to belong in the same zone.

Without zoning or a storage sharing scheme, an operating system on a server blade may discover all storage blades in the blade server chassis and continue to overwrite stored data resulting in data corruption and incorrect system behavior.

In one or more embodiments of the invention, management of the storage components of the Constellation system 100 may be divided into two functions. In one embodiment, the first function may be the Zoning Manager (ZM), which may handle the zoning of the SAS domains. The ZM may run on a Constellation Management Module (CMM) and may communicate to expanders on storage blades or expanders on NEMs 130 via bi-directional two-wire I²C links. In one or more embodiments, the ZM may be used to divide the SAS fabric into separate zone groups, each zone group consisting of a processor complex, i.e., a processor blade and a set of HDDs, either on a storage blade or on a JBOD enclosure attached via an external port on the NEM. In one or more embodiments, management of storage resources within the zones may be done using a utility referred to as the Management Client running on the processor complex owning the zone. The management client may communicate over the SAS links with the storage blades and NEMs using the industry standard SCSI Enclosure Services (SES) and Serial Management Protocol (SMP) interfaces. The management client may provide for management of the storage Blades and NEMs (HDD, storage and NEM LEDs, reporting temperature and voltage on these boards, etc.).

In one or more embodiments of the invention, there may be two zoning modes defined: managed and unmanaged. In one embodiment, in the unmanaged mode, zoning may be enabled, and slots 0 and 1 may constitute the first pair-based zone, slots 2 and 3 may constitute the second pair-based zone, and so forth. This may be termed “pair-based” zoning, and in accordance with one embodiment, if a server (processor) blade and storage blade occupy neighboring slots, the pair of server-storage blades are said to belong in the same zone. No other server blade may access the aforementioned storage blade. It may be possible that HDDs on a storage blade are unavailable for access by any server blade. It is to be noted that it may also be possible for a server blade to neighbor another server blade. In accordance with the aforementioned embodiment, the two server blades are said to be in the same zone, despite there being no storage blades for use by either server blade. All the slots in the blade server chassis may form a series of non-overlapping zones, starting with slot 0.

FIG. 1 also clearly demonstrates the abovementioned “pair-based” zoning scheme for a C10 system in accordance with one or more embodiments of the invention. The different patterns represent the four hosts (121-124), the six storage blades (111-116) and the HDDs (represented by two rectangles) in the storage blades that the hosts may respectively own. HDDs on storage blades 115 and 116 are owned by different hosts, i.e., 122 and 124. Also, a HDD each of 112 and 114 is not be assigned to any host (no pattern). The boxes within each host (11-14) represent Host Bus Adapters (HBAs). Server blade 121 and storage blade 111 occupy neighboring slots. It is clearly seen that HDDs of 111 are accessed solely by server blade 124. Storage blade 112 and server blade 122 occupy neighboring slots. It is clearly seen that HDDs of 122 are accessed by server blade 124 alone (in this case, one HDD is accessed by server blade 124 and the other is unavailable for access by any of the server blades). Server blade 123 and storage blade 113 occupy neighboring slots, and HDDs of storage blade 113 are accessed by server blade 123 alone. Similarly, server blade 124 and storage blade 114 occupy neighboring slots. One HDD of storage blade 114 is accessed by server blade 123 and the other HDD is unavailable for access.

In one or more embodiments of the invention, in order for SAS expansion ports to be securely shared by server blades, i.e., one server blade may have exclusive access to certain SAS expansion ports while other server blades may have exclusive access to other SAS expansion ports, the blade server chassis implements a “slot-ordered” zoning scheme, whereby if a server blade is located in an even slot (0, 2, 4, 6, and so on), the server blade may have exclusive access to a single SAS expansion port. The assignment of SAS expansion port to server blade may map the lowest-number SAS expansion port to the lowest numbered even slot. In other words, processor blade slot 0 may further have access to external port 0 (e.g. on both NEMs of FIG. 1), slot 2 to external port 1, slot 4 to external port 2, slot 6 to external port 3, and so forth. It is to be noted that while it may be possible for an even slot to be occupied by a storage blade, access to a SAS expansion port may still be tied to an even slot. Thus, usage of SAS expansion port by a server blade, which is not considered an optimal configuration, may be prevented by having a disk blade in an even slot.

In one or more embodiments, in the unmanaged mode, configuring the NEMs or the storage blades may be based on the locally stored configuration and without intervention from the ZM. In one embodiment, the ZM's responsibility may be to change the configuration based on a direction from a System Administrator. The configuration state may be stored in the NEMs and storage blade boards and may be used for power-up and hot plug configuration.

In the abovementioned embodiment, the issue of plugging an NEM or storage blade with an incorrect stored configuration (i.e., blade coming from some other system or another slot in this system) may be handled using the SAS address of the attached devices to confirm whether a given device may be zoned into the system. For example, if a storage blade was taken from another system, the SAS addresses of the storage blade expander may not match the addresses stored by the NEM that the storage blade may be connected to. Thus, the PHYs, i.e., link layer connectors to physical devices, of the NEM connecting to the aforementioned storage blade may be placed by the NEM in zone group 0, whose purpose is to prevent a host from discovering the HDDs on the storage blade.

Similarly, if an NEM coming from a different system is added, the Host Bus Adapter (HBA) addresses on the processor blades may not match, and thereby all the PHYs connected to the processor blades may be in zone group 0, preventing the processor blades from discovering anything at all. Further, in accordance with the same embodiment, if an expander is added with zoning disabled, the inter-expander links to this expander may be programmed to no access (group 0).

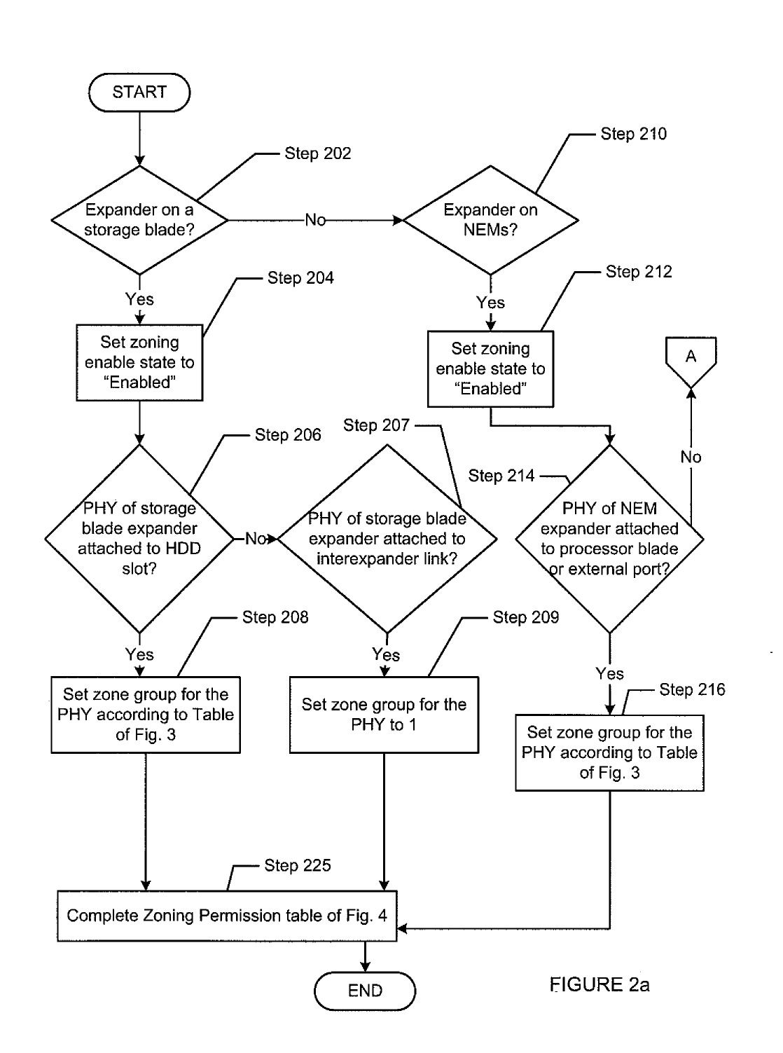

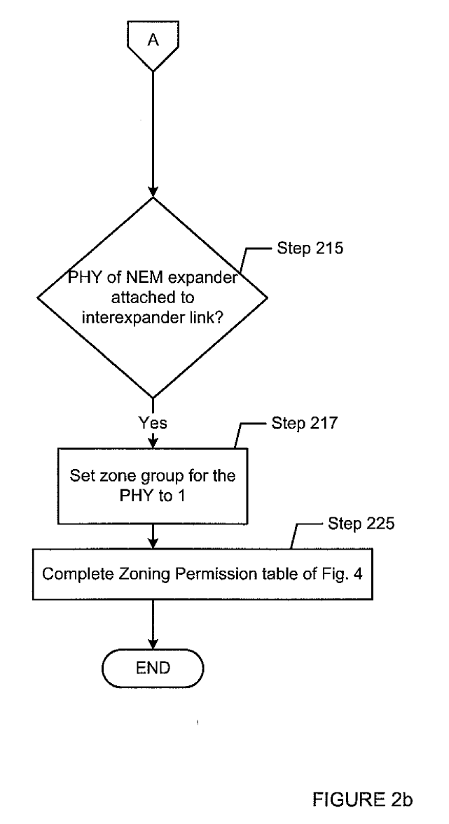

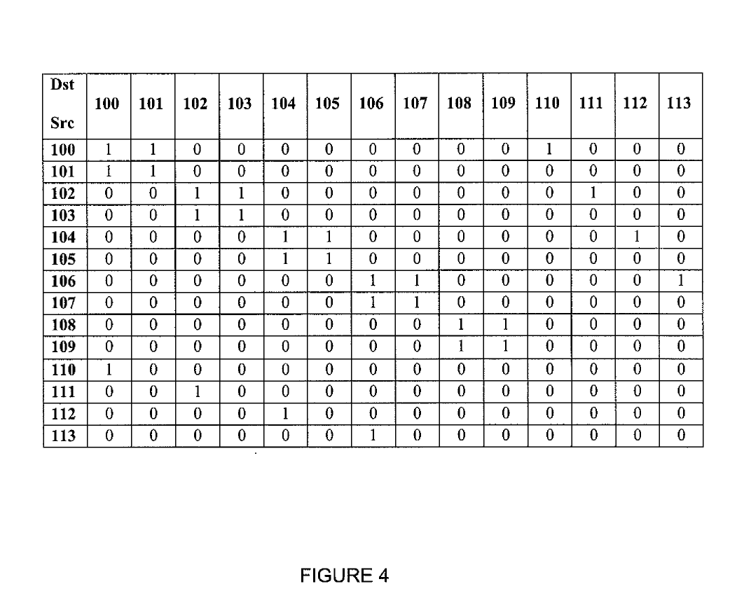

Whenever an expander is powered on, and the expander is in unmanaged mode in accordance with one embodiment, a series of actions may be taken to set the zoning permissions by the expander. The PHY of an expander may be attached to an end device (HDD slot or processor blade) or may be a PHY of an external NEM port. FIGS. 2a-2b show the steps involved in setting zoning permissions such that a Zoning Permission Table of FIG. 4 is completed.

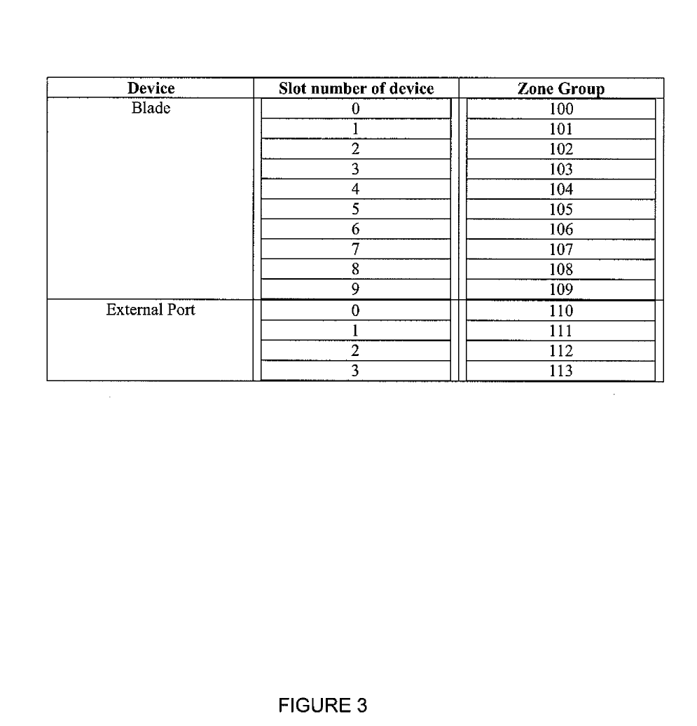

In Step 202, an expander may check for a presence thereof on a storage blade. If the expander is on a storage blade, the zoning state may be set to “Enabled” in Step 204. At Step 206, if the PHY of the storage blade expander is attached to an HDD slot, the zone group for the PHY may be set as per a table shown in FIG. 3 during Step 208. FIG. 3 shows the zone group assignments when in unmanaged mode in accordance with the abovementioned embodiment. If PHY of the storage blade expander is attached to an interexpander link as shown in Step 207, the zone group for the PHY may be set to 1 in Step 209.

In Step 202, if the expander is not present on a storage blade, the expander may check for a presence thereof on an NEM in Step 210, and the zoning state may be set to “Enabled” in Step 212. At Step 214, if the PHY of the NEM expander is attached to a processor blade or external port, the zone group for the PHY may be set as per the table shown in FIG. 3 during Step 216. PHY of the NEM expander is attached to a processor blade or external port, the PHY zone group may be set according to the table of FIG. 3. If PHY of NEM expander is attached to an interexpander link as shown in Step 215, the zone group for the PHY may be set to 1 in Step 217.

Thus, the Zoning Permission Table of FIG. 4 may be completed in Step 225. FIG. 4 shows the complete Zoning Permission Table in accordance with the embodiment of FIG. 1 as an example.

In one or more embodiments, in the managed mode, the zoning configuration may be managed by the ZM. The ZM itself may be stateless, and may manipulate the zoning state kept by each of the expanders. All changes to the zoning configuration may be done by the ZM. In one embodiment, when in managed mode, the state stored by the expanders may be restored by after a power cycle or link reset. This restoration may involve some historical checking in order to provide security against restoring incorrect state when a new blade, HDD or NEM may be installed.

In one or more embodiments of the invention, a general critical requirement is that the system may be able to boot without the presence of a ZM. Another requirement is that one client may not be able to access another client's storage resources. To satisfy both these requirements, it may be necessary for the expanders to verify that the device attached to each PHY has not changed during any link reset sequence, which may include a unit power cycle or hot-plug event. This behavior is supported by the SAS-2 specification.

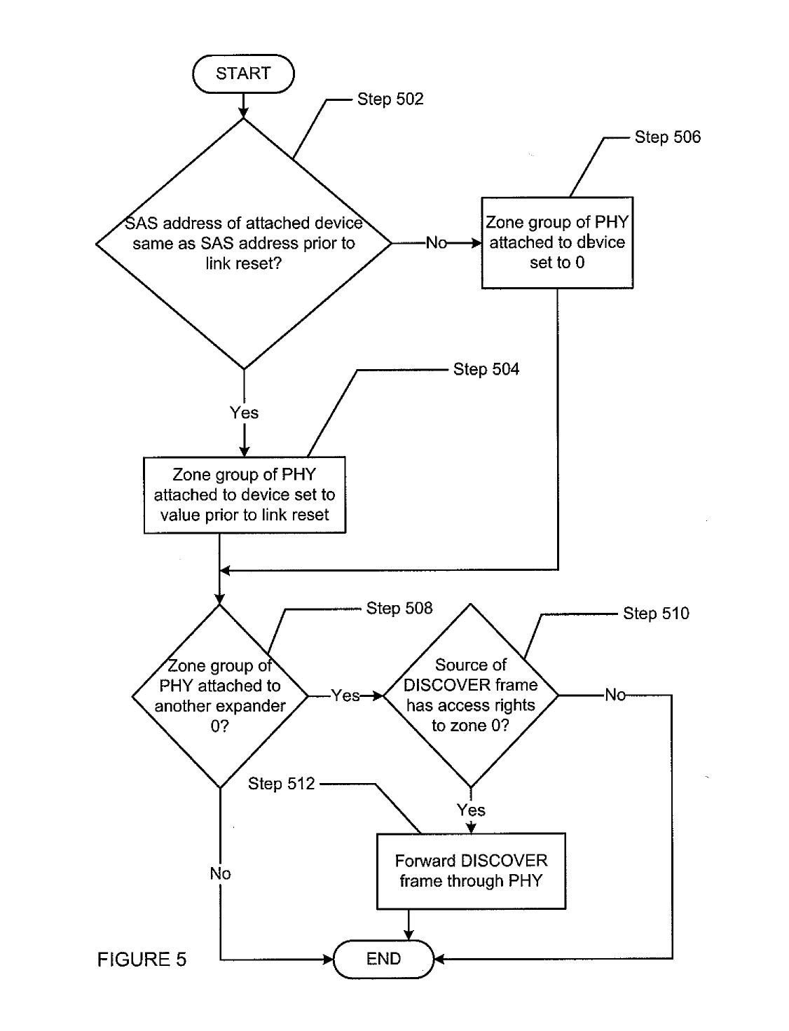

FIG. 5 shows the zoning steps involved after a link reset when in managed mode in the abovementioned embodiment of the invention. The SAS address of an attached device as received during the identification sequence may be checked for similarity of the SAS address prior to link reset in Step 502. If the addresses are identical, then the zone group of the PHY attached to the device may be set to the value prior to the link set as shown in Step 504. If the addresses are not identical, the zone group of the PHY attached to the device may be set to 0 as shown in Step 506. In Step 508, the zone group of the PHY attached to another expander may be checked as to whether the zone group is 0. If 0, the source of the DISCOVER frame having the destination address may be checked as to whether the source has access rights to zone 0 as shown in Step 510. If the source has access rights, the DISCOVER frames are forwarded through the aforementioned PHY as shown in Step 512. This may be done to prevention addition of a new storage blade or NEM such that storage resources are exposed to unauthorized clients.

It is to be noted that the above steps may also apply when the attached device is another expander to ensure that if a new module (storage or processor blade, NEM, or external JBOD) is added during a power cycle of the blade server chassis, the module may not have access to, and not provide access to other resources in the system. At the same time, the zoning configuration may be persistent for modules that are not changed during the power cycle.

In one or more embodiments, additional zoning steps may be summarized as follows.

When a processor blade is added, and the expander is in unmanaged mode, the PHYs on the NEM which connect to the added processor blade may be assigned as per the table in FIG. 3.

When a processor Blade is added, and the expander is in Managed Mode, the PHYs on the NEM expander which connect to the added processor blade may be assigned to either zone group 0 (no access) or the zone group last assigned to the PHY, i.e., value before last link reset.

When an HDD is added, and the expander is in unmanaged mode, the storage PHY connected to the added HDD may be assigned to zone group 0.

When an HDD is added, and the expander is in managed mode, the storage PHY that connects to the added HDD may be assigned to either zone group 0 (no access) or the zone group that was last assigned to the PHY, i.e., value before last link reset.

Whenever a processor or storage blade, an NEM, an HDD or external JBOD is removed, the zone group of the PHYs attached to these modules may not be changed. The zone group may be adjusted when a module is added.

In one or more embodiments, when a CMM is removed the ZM may become unavailable, but the system continues to function normally. Other than the addition of components already known to the configuration, or the swapping of components between slots and bays, no storage configuration changes may be allowed when a ZM is not available.

When the CMM is added to the system, and the ZM process starts, there may be no changes to the system. Any changes may be made by the System Administrator.

Additional rules and guidelines may be provided in one or more embodiments for zone group assignment. The rules serve to simplify the zoning process. As an example, zone groups 100-127 may be reserved for unmanaged mode and may not be used in managed mode. The two ports of a controller on a processor blade may be assigned the same zone group. An HDD may be assigned the same zone as the processor that owns the HDD.

While the invention has been described with respect to an exemplary embodiment of a blade server environment, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for partitioning SAS storage within a blade server chassis, the method comprising:
detecting the presence of a plurality of blade servers and storage blades connected to the blade server chassis;
implementing a pair-based zoning scheme such that, if a detected server blade and a detected storage blade occupy neighboring slots in the blade server chassis, the detected server blade and detected storage blade occupying neighboring slots are set to be in the same zone; and
restricting access to the detected storage blade occupying a neighboring slot to a blade server to only the blade server occupying the neighboring slot.

2. The method according to claim 1, wherein if a blade server neighbors another blade servers, the two server blades are set to be in the same zone.

3. The method according to claim 1, wherein slots in the blade server chassis form a series of non-overlapping zones, starting with slot 0.

4. The method according to claim 1, wherein slot 0 and slot 1 form a first pair-based zone, slot 2 and slot 3 form a second pair-based zone, and so forth.

5. The method according to claim 1, wherein there are two zoning modes, a managed mode and an unmanaged mode.

6. A method for partitioning SAS storage within a blade server chassis, the method comprising:
detecting the presence of a plurality of blade servers, storage blades, and expansion ports of SAS switches connected to the blade server chassis;
implementing a slot-ordered zoning scheme such that, if a detected server blade is located in an even slot, the blade server is given exclusive access to a single SAS expansion port; and
restricting access to the SAS expansion port to a blade in an even slot
wherein presence of a storage blade in an even slot prevents usage of the SAS expansion port by a blade server.

7. The method according to claim 6, wherein there are two zoning modes, a managed mode and an unmanaged mode.

8. The method according to claim 5, wherein in the unmanaged mode configuration of a plurality of storage blades is done based on a locally stored configuration.

9. The method according to claim 7, wherein in the unmanaged mode configuration of a SAS expansion port is done based on a locally stored configuration.

10. The method according to claim 8, wherein if a PHY of a storage blade expander is attached to an HDD slot, a zone group for the PHY is set according to a table.

11. The method according to claim 10, wherein zoning permissions are set.

12. The method according to claim 9, wherein if the PHY of a storage blade expander is attached to a processor blade or an external port, the zone group for the PHY is set according to a table.

13. The method according to claim 12, wherein zoning permissions are set.

14. The method according to claim 5, wherein in the managed mode, zoning configuration is managed by a stateless zoning manager that manipulates a zoning state kept by at least one expander.

15. The method according to claim 7, wherein in the managed mode, zoning configuration is managed by a stateless zoning manager that manipulates a zoning state kept by at least one expander.

16. The method according to claim 15, wherein the zoning manager uses bidirectional I²C links to communicate with the at least one expander.

17. The method according to claim 15, wherein a state stored by the expanders is unchanged by a power cycle.

18. The method according to claim 15, wherein a state stored by the expanders is unchanged by a link reset.

19. A consolidated data storage and computing system comprising:
a chassis capable of receiving a plurality of blade servers and disk blades;
a plurality of hosts;
a plurality of targets; and
expanders for connecting the plurality of hosts and the plurality of targets,
wherein a pair-based zoning scheme is implemented such that, if a server blade and a disk blade occupy neighboring slots in a blade server chassis, the server blade and the disk blade are set to be in the same zone.

20. A consolidated data storage and computing system comprising:
a chassis capable of receiving a plurality of blade servers and disk blades;
a plurality of hosts;
a plurality of targets; and
expanders for connecting the plurality of hosts and the plurality of targets,
wherein a slot-ordered zoning scheme is implemented such that, if a detected server blade is located in an even slot, the blade server is given exclusive access to a single SAS expansion port.
